(19) United States
(12) Patent Application Publication
(10) Pub. No.: US 2020/0290301 A1
(43) Pub. Date: Sep. 17, 2020

(54) FLUID FORMING APPARATUS

(71) Applicant: FF FLUID forming GmbH, Lastrup/Nieholte (DE)

(72) Inventor: Reinhold Wesselmann, Lastrup (DE)

(73) Assignee: FF FLUID forming GmbH, Lastrup/Nieholte (DE)

(21) Appl. No.: 16/782,747

(22) Filed: Feb. 5, 2020

(30) Foreign Application Priority Data
Feb. 5, 2019 (EP) 19155613.3

(51) Int. Cl. B30B 1/00; B21D 26/039

(52) U.S. Cl. CPC B30B 1/003; B21D 26/039

(57) ABSTRACT

A fluid forming apparatus includes a main frame having at least two tensile frame struts extending along a clamping axis and adapted to carry a tensile force along the clamping axis. An upper pressure plate and a lower pressure plate are arranged inside a frame space, and a tool space is disposed between the upper and the lower pressure plate, the tool space being adapted to take up a fluid forming tool mold. A first closure pressing unit is arranged inside the frame space such that by a pressure force exerted by the closure pressing unit, a pressure closing force along the clamping axis is exerted onto the upper and lower pressure plates, wherein the upper pressure plate, the lower pressure plate, the tool space and the first closure pressing unit are arranged in a functional serial arrangement along the clamping axis.

### CROSS-REFERENCE TO FOREIGN PRIORITY APPLICATION

The present application claims the benefit under 35 U.S.C. §§ 119(b), 119(e), 120, and/or 365(c) of EP 19155613.3 filed Feb. 5, 2019.

### FIELD OF THE INVENTION

The invention relates to a fluid forming apparatus, and more particularly to a fluid forming apparatus having a main frame within which is situated a first closure pressing unit comprising a first fluid cavity delimited by a first flexible membrane and being connected to a pressurized closure pressing fluid source that capable of forming large sheet metal components.

### BACKGROUND OF THE INVENTION

Fluid forming, which is also understood as high pressure forming, is a specific method for forming three-dimensional objects in a cold or warm forming process of a plastically deformable material. The principle of fluid forming is to apply a hydrostatic pressure via a fluid like water, hydraulic fluid or the like onto a material and to hereby deform the material into a molding form, typically a molding cavity. The molding cavity defines the geometry of the molded product. The pressure can be applied as an internal or external pressure onto the material meaning that an internal pressure could be applied into a cavity thus expanding the material defining the cavity or an external pressure could be applied onto a sheet material, thus pressing the sheet material into a molding cavity.

The hydroforming manufacturing process allows forming of complex geometrical components inducing only very small variations of material thickness in a one-step forming process or a forming process with less forming steps than comparable conventional manufacturing methods like deep drawing or pressing in conventional molds. In order to conduct the hydroforming process in an efficient manufacturing sequence, it is required to decrease the time for placing the material to be molded into the fluid forming tool, to conduct the fluid forming process and to remove the molded component out of the tool to hereafter start a new molding process again as far as possible. At the same time, however, it is required to apply a sufficient closing force onto the mold to ensure secure sealing of the mold versus the material to be molded, since otherwise the pressurized fluid used for the molding process would tend to escape out of the molding tool. A general problem associated with these requirements is both the need for a high closing force to fulfill the requirements when molding large products with high material thickness, but to allow sufficient opening amplitude to facilitate handling and allow the manual or automatic removal of the molded components.

As a further problem related to fluid forming, the high pressure applied in the molding process by the pressurized fluid tends to deform the whole fluid forming apparatus or parts thereof. These deformations occurring under the load during the molding reduce the precision of the molding process and may lead to frictional blockage of components, which shall move in relation to each other in the course of the molding process.

Whilst this problem may be addressed by increasing the material strength and thickness of relevant components, this approach will result in the apparatus becoming heavy and bulky and is thus limited by transport capacities and the like. Thus, fluid forming apparatuses with increased capacity with regard to the magnitude of pressure and the dimension of the sheet material cannot be manufactured in a proper dimensioning with this approach.

EP 1 462 191 B1 discloses a fluid forming apparatus, wherein a tool carrying component comprises a first plate and a plurality of pistons, which loosely stand on the plate. Further, a cylinder plate adapted to take up the pistons in a corresponding plurality of cavities is part of the apparatus. By this, a fluid pressure can be applied to the pistons and a homogeneous distribution of the force required for closing of the tool can be applied without the need for heavy or bulky components. However, this type of fluid forming apparatus has proven to show some limitations when using the apparatus for fluid forming of large sheet metal parts under very high pressure. In such applications, it is required to set up the fluid forming apparatus with a large number of pistons or with pistons with large dimensions, both resulting in an increased probability of leakage of the pressurized fluid out of a cavity sealed by such pistons.

DE19937694A1 discloses a press for pressing chipboards or plastic sheets. The apparatus disclosed herein comprises a membrane adapted to apply a pressing force and to transfer heat from a liquid transfer material filling the cavity covered by the membrane. The apparatus is neither adapted nor intended to serve as a fluid forming apparatus, and in particular has no space to take up a fluid forming tool.

U.S. Pat. No. 5,927,120A discloses an apparatus for performing a hydroforming operation. This apparatus is adapted to take up a two die sections for taking up a workpiece for an internal pressure fluid forming action. The two die sections are arranged in a closed arrangement to each other thus forming a die cavity wherein a tube-like working piece is arranged and then expanded by internal pressure inside the working piece. The two cavities define an exact geometry of the workpiece to be formed in the apparatus. The die sections must thus be kept in such close contact during the forming operation by an inflatable bladder applying a closing force induced by an internal pressure in the bladder. No relative movement of the two die sections versus each other is allowed during said forming operation to be induced by the closing force. By this, the working piece may be expanded to an exact geometry corresponding to the shape of the die cavity.

### SUMMARY OF THE INVENTION

It is an object of the invention to provide a fluid forming apparatus, which overcomes these problems and is capable of forming large sheet metal components with significant thickness under the corresponding high pressure in an efficient fluid forming process.

This object is achieved by a fluid forming apparatus as described in the introductory portion, wherein the first closure pressing unit comprises a first fluid cavity, the fluid cavity being delimited by a first flexible membrane and being connected to a pressurized closure pressing fluid source.

The fluid forming apparatus comprises a main frame, further comprising at least two tensile frame struts extending along a clamping axis and adapted to carry a tensile force along the clamping axis. The main frame circumscribes an inner frame space which extends along the clamping axis and is delimited by an upper and a lower frame plate at two sides opposed to each other along the clamping axis, wherein the upper and lower frame plate are connected with each other by the at least two tensile frame struts. An upper pressing plate is arranged inside the frame space, a lower pressing plate is arranged inside the frame space, and a tool space is disposed between the upper and the lower pressing plate, the tool space being adapted to take up a fluid forming tool mold. A first closure pressing unit is arranged inside the frame space in a functional serial arrangement to the upper and lower pressing plate, such that by a pressure force exerted by the closure pressing unit, a pressure closing force along the clamping axis is exerted onto the upper and lower pressing plates, wherein the upper pressing plate, the lower pressing plate, the tool space and the first closure pressing unit are arranged in a serial arrangement along the clamping axis.

According to the invention, the closing movement and force required to close the fluid forming tool mold and to effect a reliable sealing of the tool mold versus the material to be formed is applied by a closure pressing unit, which comprises a fluid cavity, which is delimited by a flexible membrane. The fluid cavity is connected to a source of a pressurized fluid and can thus be set under high pressure. The cavity may be formed as a recess in a plate or may be established in between a planar surface and the membrane. The membrane allows for a displacement along the clamping axis of the fluid forming apparatus and thus generally allows for closing the tool and applying a high closing force. The invention is based on the inventors' finding that a membrane can safely be clamped along its periphery to withstand the pressure exerted in a fluid forming process to close the mold tool. One aspect is the possibility to use a membrane with a large dimension, whereby the surface to which the pressure is applied to produce the closing force is significantly increased compared to a solution employing a plurality of pistons. At the same time, a membrane does not require such precise lateral guidance like pistons to fulfill the sealing requirements, but tolerates a certain degree of a play. This results in that although a membrane itself must be expected to have smaller resistance against high pressures than a piston, a solution with a membrane is capable of applying a high closing force with a reliable sealing, which is superior to a solution with multiple pistons.

The fluid forming apparatus according to the invention is used for an external pressure fluid forming of workpieces. In such a process, a sheet material is restrained along its peripheral circumference by a clamping force. A fluid pressure is applied on one side of the sheet material inside a pressure cavity formed by the sheet material and a first section of a molding tool. This first section of the molding tool may be a universal molding tool section and may only comprise a channel for directing a pressurized fluid and a distributing geometry for distributing the pressurized fluid over the one side of the sheet material.

By applying said pressurized fluid externally on one side of the sheet material, the sheet material is deformed and pressed into a molding cavity of said second section of the molding tool. This molding cavity is individually formed and defines the geometry of the workpiece after the molding process. Thus, the molding tool comprises only one section which defines the geometry of the workpiece, wherein the other molding tool section may comprise a pressurized fluid channel only. The sheet material is inserted between the first and the second section of the molding tool. After insertion of the sheet material between the two sections of the molding tool, the two sections are moved by a closing movement applied by the membrane according to the invention and thus the sheet material is restrained along its periphery along its circumference and sealed along a clamping line between said two sections of the molding tool. The pressure applied by said membrane maintains the sheet material in a semi-sealing engagement between the two sections of the molding tool. Thus, a small amount of leakage of the pressurized fluid passes through the semi-sealing engagement along the clamping line between the two sections of the molding tool and the sheet material. By this, the sheet material is allowed to conduct a relative movement which is directed from the periphery of the sheet to the centre of the sheet. This movement is induced by the centre of the sheet being pressed into the molding cavity in the second section of the molding tool. Since such movement of the sheet at its peripheral clamping line between the two molds is possible, the forming of the sheet is not produced by a mere plastic deformation of the sheet material but rather is further allowed by some sheet material flowing from outside of the clamping line to inside of the clamping line by the movement of the peripheral sections of the sheet material towards the centre through the clamping line. According to the invention, the membrane allows a very homogenous distribution of the closing force thus allowing this movement of the sheet material through the clamping line to be rather constant along the whole length of the clamping line. Further, the small leakage of pressurized fluid lubricates this movement. As a result, a homogeneous drawing-in of the sheet material is reached by the membrane-clamping-force. By this, much larger deformation rates of the sheet material can be realized than in conventional clamping systems.

It is understood, that the clamping line will comprise an upper clamping line between the metal sheet material and the upper mold part and a lower clamping line between the sheet material and the lower mold part.

It is thus of importance to have a control for controlling the pressurized fluid applied to the membrane at a pressure level which is constant at such a level as to apply a closing movement and closing force which allows a small leakage of pressurized fluid and a small movement for drawing-in of the sheet material in a direction from its periphery to its center portion. It is further preferred that the membrane allows a small closing movement in a direction perpendicular to the membrane surface. By this, the clamping action can be accomplished as required in an external fluid forming apparatus.

According to the invention, the fluid forming apparatus employs a main frame, which serves to take up the pressure forces, which are applied during fluid forming process. These pressure forces are understood to be the pressure applied in the fluid forming process itself and the pressure applied onto the membrane to effect the closing and sealing of the mold. The frame takes up these pressures by a tensile force acting on two or more tensile frame struts. These tensile frame struts usually extend along the clamping axis, which in most arrangements is oriented vertically. It is understood that any definition of up and down, upper and lower or the like as used in the context of the invention relates to such conventional vertical arrangement of the clamping axis. These tensile frame struts connect an upper and a lower frame plate with each other and these upper and lower frame plates serve to transfer the loads onto the tensile frame struts. The upper and lower frame plates are understood to form a support for taking up the forces induced by the pressure applied to seal the mold form and to effect the forming of the workpiece. The upper and lower frame plates may be formed as sheets or boards or may be formed by multiple struts or by any other load-bearing structure defining a load bearing surface.

It is understood that thus, the upper and lower frame plates are loaded with a significant load profile including a bending force, shear forces, which tend to deform these upper and lower frame plates. However, such deformation may be accepted and leveled out by the fluid forming apparatus according to the invention, since the closing unit includes the membrane and thus can compensate such deformations without any negative effect on the function. Thus, the upper and lower frame plates may be smaller dimensioned than in a conventional fluid forming apparatus.

The fluid forming apparatus according to the invention further comprises upper and lower pressing plates. These pressing plates serve to define the counterpart for the fluid forming tool mold. It is generally preferred that one of the pressure plates is positioned between the closure pressing unit and the tool space such that, e.g., the fluid cavity may be formed in the pressure plate or by a surface of the pressure plate and the membrane may be fixed to the pressure plate. In specific embodiments, one of the pressure plates may be integral with the upper or lower frame plate, which may be stiff enough to carry the load during the fluid forming process in such case.

The upper pressing plate, the lower pressing plate, the tool space and the first closure pressing unit are arranged in a serial arrangement along the clamping axis. This is understood that the load exerted by the closure pressing unit and the load during the fluid forming process exerted in the tool space must be carried by each of these components alone, i.e., no two or more of these components are positioned for a parallel carrying and thus sharing of the load. It is understood that actually the upper and lower frame plates are in a serial arrangements to these components, too and transfer the load onto the tensile frame struts. The tensile frame struts are arranged in a parallel arrangement to each other and thus share the tensile force to be carried by the frame. The equivalence of forces thus implies the compressive loads carried by the components between the upper and lower frame plates being in equivalence with the sum of tensile forces carried by the tensile frame struts.

According to the invention, a reliable application of the closing force by a pressurized fluid pressed into a fluid cavity, which is delimited by a membrane, is provided. By this, a compensation of deformations is reached and the need for heavy and bulky dimensioning of the components of the apparatus is avoided.

According to a first aspect of the invention the upper and the lower pressing plate comprise a tool surface area lying in a plane perpendicular to said clamping axis and facing towards said tool space and wherein said first membrane comprises a pressurized membrane face having a size of at least 75% of the tool surface area. According to this aspect of the invention, the membrane has a pressurized surface area of at least 75% of the tool surface area of the upper and lower pressing plate. The tool surface area is understood to be the surface of the upper or lower pressing plate, respectively, which faces the tool space and thus is available to abut the fluid forming tool mold. It is further understood that the tool surface area of the upper and lower pressing plate is understood as the tool surface area of the upper pressing plate or the tool surface area of the lower pressing plate, whichever is smaller. Note that the tool surface area may not be fully covered if small fluid forming tool molds are employed. The tool surface area is understood to be oriented in a direction perpendicular to the clamping axis. According to this aspect, a certain minimum size of the membrane is defined. Using a membrane with such a dimension provides a sufficient magnitude of the closing force under an acceptable pressure level exerted in the fluid space delimited by the membrane. It is understood that in other embodiments, the minimum percentage of the pressurized surface area of the membrane may be at least 70%, at least 60% of the tool surface area or even less.

According to a further preferred embodiment, the first membrane has a rectangular geometry in a plane perpendicular to said clamping axis. The inventors have found that a membrane with a rectangular cross section allows for a reliable clamping and sealing of the membrane along its periphery and at the same time provides a large size of the pressurized membrane area thus resulting in a high closing force at reasonable pressure applied to the membrane. Further, such a rectangular membrane is advantageous since it allows to apply a uniform pressure over a fluid forming tool mold which has a rectangular cross section. Such rectangular tool molds are much often used. It is to be understood that a rectangular cross section is understood as a geometry being inscribed in a rectangle. Thus, the two longitudinal edges are parallel and the two transversal edges are parallel and perpendicular to the longitudinal edges. This does not exclude rounded or beveled corners of the membrane or otherwise shaped corners different from a sharp rectangular corner. Such rounded or beveled or otherwise shaped corners are much often used to allow a proper clamping and sealing of the membrane.

Still further it is preferred that the first membrane is composed of a plurality of membranes arranged adjacent to each other and lying in a plane perpendicular to the clamping axis. According to this embodiment the membrane may be composed of two, three, four, or even more separate membranes which are arranged adjacent and flush to each such as to form a segmented membrane. By this, an efficient use and coverage of the space available for the membrane can be achieved thus producing a sufficient closing force by the sum of the forces resulting from the membranes under pressure.

Still further, it is preferred in a further embodiment that the fluid forming apparatus comprises a first stamp plate, the first stamp plate extending perpendicular to the clamping axis and being displaceable along the clamping axis wherein the first membrane has a first membrane surface facing towards the fluid cavity and a second membrane surface abutting the first stamp plate. According to this embodiment, a stamp plate is provided which directly abuts and thus supports the membrane. Such a stamp plate effectively reduces the deformation of the membrane and may, in particular, reduce the membrane amplitude in the middle of the membrane by such a support. It is understood that such a stamp plate need no precise guidance for its longitudinal movement along the clamping axis, i.e., a certain degree of lateral play is acceptable for the function of such a stamp plate. The stamp plate, however, will reduce the degree of elastic deformation of the membrane under the cyclic loading and thus reduce fatigue effects of the membrane and allows for a long maintenance interval with regard to the membrane.

It is further preferred to improve the fluid forming apparatus in that it further comprises a second closure pressing unit arranged inside the frame space in a functional serial arrangement to the upper and lower pressing plate such that by a pressure force exerted by the second closure pressing unit, a pressure closing force along the clamping axis is exerted onto the upper and lower pressing plates, wherein the first and the second closure pressing unit, the upper pressing plate, the lower pressing plate and the tool space are arranged in a serial arrangement along the clamping axis, wherein the second closure pressing unit comprises a single or a plurality of second fluid cavities and a corresponding single or a plurality of second flexible membranes, wherein each of the second fluid cavities is delimited by a second flexible membrane and is connected to a source of a pressurized fluid. According to this preferred embodiment, two closure pressing units are provided in the apparatus. The provision of such two closure pressing units allows compensating any deformations on both sides of the tool space if the tool space is positioned between the first and the second enclosure pressing unit. Further, such two closure pressing units may serve to increase the amplitude of opening and closing of the fluid forming tool mold such that molded parts with a larger dimension along the clamping axis can be taken out of the tool mold after forming. It is understood that the second closure pressing unit may be configured and designed similar to the first closure pressing unit and may, in particular, be positioned such as to be mirror-symmetrical with reference to a horizontal plane, which is perpendicular to the clamping axis in the tool space. The first and the second fluid cavity can be connected to the same source of a pressurized fluid and thus, a similar pressure is applied to the first and the second fluid cavity.

According to an alternative embodiment hereto, the fluid forming apparatus may be further improved by comprising a second closure pressing unit arranged inside the frame space in a functional serial arrangement to the upper and lower pressing plate such that by a pressure force exerted by the second closure pressing unit, a pressure closing force along the clamping axis is exerted onto the upper and lower pressing plates, wherein the first and the second closure pressing unit, the upper pressing plate, the lower pressing plate and the tool space are arranged in a serial arrangement along the clamping axis, wherein the second closure pressing unit comprises a plurality of second fluid cavities, the second fluid cavities being arranged in an adjacent arrangement in a direction perpendicular to the clamping axis, wherein a piston is disposed in each of the fluid cavities, the piston sealing the fluid cavity, respectively and being moveable in a direction along the clamping axis in relation to the fluid cavity. According to this embodiment, a second closure pressing unit is provided and is build up by multiple pistons as disclosed in the prior art according to EP 1 462 191 B1. By this combination of a first closure pressing unit employing a membrane, and second closure pressing units employing multiple pistons, a beneficial combination is achieved wherein the number of pistons can be significantly reduced and the benefit of a larger amplitude reached by the second closure pressing unit employing the pistons is included in the apparatus. Thus, this embodiment is particularly suited for large components to be molded with a significant degree of deformation in the direction of the clamping axis and thus a significant dimension in the direction requiring a sufficient opening amplitude of the tool molds to take out the formed part out of the tool mold.

According to a further preferred embodiment, the first closure pressing unit is adapted to have a closure pressing maximum height defined by a maximum deflection of the first membrane and a closure pressing minimum height defined by the thickness of the membrane and wherein the closure pressing maximum height minus the closure pressing minimum height define a closure pressing amplitude of the first closure pressing unit, further comprising a first shifting unit, the first shifting unit being adapted to be shifted from a shifting minimum height to a shifting maximum height and vice versa, wherein the shifting maximum height minus the shifting minimum height define a shifting amplitude of the first shifting unit, wherein the closure pressing minimum height, the closure pressing maximum height, the shifting minimum height and the shifting maximum height are oriented in the direction of the clamping axis, wherein the first shifting unit, the upper pressing plate, the lower pressing plate, the tool space, the first closure pressing unit and the first shifting unit are arranged in a serial arrangement along the clamping axis, wherein the shifting amplitude is at least two times, preferably five times the closure pressing amplitude.

While generally the first and, if present, the second closure pressing unit will not only provide a closure pressing force along the clamping axis but further a closure displacement which allows to release the fluid forming tool mold or one part of the tool mold out of its position between the upper and lower pressing plate if no closing force is applied it is understood that this closure displacement may have a rather small travel path to prevent high stretching of the first or second membrane. In many applications, such small travel path will be sufficient to move out one of the parts of the tool mold to remove the formed workpiece after the fluid forming is finished. However, in some designs of a tool mold a larger travel path may be required to allow horizontal movement of one part of the tool mold for removing the formed workpiece. In such case, a shifting unit may be provided which can be switched from a position with large height to a position with small height in the direction of the clamping axis. The amplitude between the small and large height may be a multiple of the amplitude represented by the travel path provided by the membrane. By this, fluid forming tool molds having toll mold parts which are toothed or interlocked with each other to a certain degree may be employed.

According to a further preferred embodiment, the fluid forming apparatus further comprises a first shifting unit, comprising a first recess unit having a first side comprising a at least one recess and a first protrusion unit having a first side comprising at least one protrusion, wherein the first side of the first recess unit and the first side of the first protrusion unit face each other, wherein the first recess unit, the first protrusion unit, the upper pressing plate, the lower pressing plate, the tool space, the first closure pressing unit and the first shifting unit are arranged in a serial arrangement along the clamping axis, wherein the first recess unit and the first protrusion unit extend along a direction perpendicular to the clamping axis and are displaceable in relation to each other in the direction perpendicular to the clamping axis and in a direction along the clamping axis, such that in a first, open position said protrusion is positioned inside the recess to establish a short height of the first shifting unit in a direction of the clamping axis, and in a second, closed position the protrusion is supported on said first side of the first recess unit sideways from the recess to establish a large height of the first shifting unit in the direction along the clamping axis, the large height being larger than the short height.

According to this embodiment, a shifting unit is provided, which is in serial arrangement to the other components between the upper and lower frame plate. The shifting unit comprises a first recess unit which may be formed as a plate and a first protrusion unit which may be formed as a plate, which comprise a single or multiple recesses and a single or multiple protrusions, wherein a protrusion fits into a recess. In an arrangement, wherein the protrusions are positioned inside the recess, the shifting unit thus has a small height. In another, closed position of the shifting unit, the protrusions are supported on the recess unit by a support surface lying sideways from the recesses with respect to the clamping axis. Thus, in this position, the height of the shifting unit is increased. The shifting unit thus allows by a combination of a lateral and vertical movement of the recess unit versus the protrusion unit to provide either a large dimension or a small dimension in the direction of the clamping axis. This enables the fluid forming apparatus to significantly increase the opening amplitude of the fluid forming tool mold and thus allows inserting or taking out parts with a significant dimension in the direction of the clamping axis. It is understood that such furcated intermeshing design of the recess unit and the protrusion unit needs not to provide a significant stiffness of the recess or protrusion plate, since any such deformation can be compensated by the pressure closing unit of the apparatus. Thus, a combination of such a protrusion and recess unit with a pressure closing unit employing a membrane according to the invention provides for both a less bulky design of the apparatus with a large amplitude of the mold for opening and closing the mold in the direction of the clamping axis by, at the same time, allowing high pressure fluid forming of large metal sheets. It is further understood that the first recess unit may be integral with an upper or lower frame section of the fluid forming apparatus. In this embodiment, the upper or lower frame section is designed to comprise one or a plurality of recesses adapted to take up the protrusions of the protrusion unit inside the recesses in an outward shifted position of the protrusion unit. In particular, the frame may be built from a plurality of frame segments arranged in parallel to each other, wherein recesses are provided between the frame segments to take up the protrusions of the protrusion unit inside the recesses in an outward shifted position and wherein the protrusions are supported onto the frame segments in an inward shifted position.

According to a further preferred embodiment, the apparatus comprises a second shifting unit, the second shifting unit comprising a second recess unit having a first side comprising at least one recess and a second protrusion unit having a first side comprising at least one protrusion, wherein the first side of the second recess unit and the first side of the second protrusion unit face each other, wherein the first recess unit, the first protrusion unit, the second recess unit, the second protrusion unit, the upper pressing plate, the lower pressing plate, the tool space and the first closure pressing unit are arranged in a serial arrangement along the clamping axis, wherein the second recess unit and the second protrusion unit extend along a direction perpendicular to the clamping axis and are displaceable in relation to each other in the direction perpendicular to the clamping axis and in a direction along the clamping axis, such that in an open position the protrusion is positioned inside the recess to establish a short height of the second shifting unit in a direction of the clamping axis, and in a closed position the protrusion is supported on the first side of the second recess plate sideways from the recess to establish a large height of the second shifting unit in the direction along the clamping axis, the large height being larger than the short height.

It is understood that by providing a first and a second shifting unit, the amplitude of opening of the tool mold can be doubled and thus, the capacity for molding parts with a larger dimension in the clamping axis is increased. It is understood that the first and the second shifting unit can be designed with a similar design and dimension and may preferably be positioned mirror-symmetrical with regard to a horizontal plane perpendicular to the clamping axis through the tool space. By this, one of the shifting units is disposed above the tool space and one of the shifting units is disposed below the tool space and thus, any deformations of the shifting units can be compensated well, in particular, if a first and a second closure pressing unit are provided, which are disposed above and below the tool space as well.

According to a further preferred embodiment with a first or a first and a second shifting unit, the fluid forming apparatus may be further improved in that wherein the first and the second recess units, if applicable, comprises at least two recesses and the first and the second protrusion unit, if applicable, comprises at least two protrusions, wherein each of the protrusions is positioned inside one the recesses in the open position and each of the protrusions is supported on the first side of the first and second recess unit, respectively, sideways from one of the recesses in the closed position, or wherein the first and the second recess unit, if applicable, comprises at least one recess and at least one protrusion and the first and the second protrusion unit, if applicable, comprises at least one protrusion and at least one recess, wherein each of the protrusions is positioned inside one of the recesses in the open position and each of the protrusions is supported on the first side, respectively, sideways from the at least one recess in the closed position. According to this embodiment, a plurality of protrusions and recesses are provided at each shifting unit, wherein the protrusions may either be provided at one of the plates only with the recesses being provided at the other plate, respectively, or the protrusions and recesses being provided at both plates, wherein it is understood that in the open position a protrusion of the one plate matches with a recess of the other plate.

It is further preferred that the first recess unit or the first protrusion unit is defined by the upper frame plate and/or the second recess unit or the second protrusion unit is formed by the lower frame plate. According to this embodiment, the first recess unit or the first protrusion unit and the upper frame plate form an integral part in that the recesses or protrusions, respectively, are provided at the upper frame plate, and correspondingly the lower frame plate.

In particular it is further preferred that the upper and/or lower frame plate comprises a plurality of struts being arranged in a distance to each other such that a space is provided between two adjacent struts, wherein the space forms the recess. By this embodiment a preferred configuration of the upper or lower frame plate being formed by a plurality of struts, which may run parallel to each other and which may leave space between each other is employed to provide the recesses to form the first or second recess unit, respectively.

According to a further preferred embodiment, the fluid forming apparatus further comprises a fluid forming tool mold, wherein the fluid forming tool mold comprises an upper mold part and a lower mold part, the upper and lower mold part being positioned one on the other in relation to the clamping axis such that an abutting face of the upper mold part faces an abutting face of the lower mold part and the abutting face of the upper mold part establishes an upper sealing surface, and the abutting face of the lower mold part establishes a lower sealing surface, and the sealing surfaces surrounding a fluid forming cavity provided in an abutting face of one of the upper and lower mold part, wherein the corresponding other part of the upper and lower mold part comprises a fluid channel connected to a pressurized molding fluid source, the fluid channel having an opening in the abutting face opposed to the fluid forming cavity. According to this embodiment, a fluid forming tool mold is included, which preferably is a two-part mold with an upper and a lower mold part. Either one of the two mold parts comprises a recess defining the geometry of the molded part, wherein the other part might comprise a single or a plurality of channels connected to a source of a pressurized fluid to impart the fluid pressure required for the molding process. The upper and lower mold part are adapted to establish a sealing to a workpiece inserted between the upper and lower mold part, such that the fluid forming pressure can be applied without leakage of the pressurized molding fluid. Generally, in a configuration where the forming fluid is applied via a fluid channel in the upper tool mold part, it is understood that the upper sealing surface may provide a sealing effect against the workpiece whereas the lower sealing surface is understood to not necessarily provide a sealing effect against the workpiece, but rather serves as an abutting surface to impart a pressure onto the workpiece to press the workpiece against the upper sealing surface. In a vice versa condition, with the fluid channel being formed in the lower tool mold part, the lower sealing surface will form such a sealing against said workpiece with the upper sealing surface acting as an abutment surface rather. In some particular embodiments both the upper and the lower mold part may comprise a geometrical surface used to define and effect the plastic deformation of the workpiece. In such an embodiment a first one of the two mold parts may effect a preforming of the workpiece in the course of closing the mold whilst the second mold part defines the final geometry of the workpiece when being deformed by the pressurized fluid. The pressurized fluid may be injected via the first mold part.

It is further preferred that the upper or lower mold part comprising the fluid forming cavity further comprises a protruding section which protrudes above the sealing surface of the upper or lower mold part comprising the fluid forming cavity in the direction towards the respective other lower or upper mold part. Generally the lower mold part may comprise a cavity only lying below the lower sealing surface such that the workpiece is molded into the cavity by a pressurized molding fluid injected via a fluid channel in the upper mold part to mold a workpiece. However, some workpieces having a specific geometry with a big dimension in the direction of the clamping axis may preferably be formed in such a way that a protrusion above the lower sealing surface is present in the lower mold part such that the workpiece is somewhat preformed upon closing of the tool mold and the pressurized molding fluid will then mold the workpiece directly to the surface of the protrusion and, if applicable, further into a cavity in the lower mold part.

It is further preferred that the pressurized molding fluid source has a pressure which is higher than the pressurized closure pressing fluid source, in particular, wherein the pressurized molding fluid source has a pressure which is at least 150% of the pressurized closure pressing fluid source. According to the invention, a membrane is employed to impart the closing force. The membrane has the principal advantage to be able to cover a large surface area and thus may impart a high force even at low pressure of the pressurized closure pressing fluid. Thus, the pressure of the pressurized closure pressing fluid may be significantly smaller than the pressure of the pressurized molding fluid which is applied to a rather small surface area only, in particular, to a surface area which is significantly smaller than the surface area pressurized at the membrane.

This ratio can be employed without the risk of leakage or even the risk of opening of the tool mold. It is understood, that the pressurized molding fluid source may have a pressure which is at least 125%, 175%, 200%, or even 250% of the pressurized closure pressing fluid source.

It is further preferred that the sealing surface comprises a first surface section and a second surface section, the first surface section and second surface section being arranged in a distance to each other with respect to a direction along the clamping axis. According to this embodiment the sealing surface is not lying in a single plane which is perpendicular to the clamping axis but is formed a continuous sealing surface which comprises at least two surface sections positioned in a distance to each other along the clamping axis. By this, a tool mold having a specific geometry may be employed and in particular a tool mold with a protrusion could be employed, wherein it is understood that said protrusion may protrude above only one of the two sections of the sealing surfaces or above both sections of the sealing surface.

It is further preferred that the upper or lower fluid forming tool mold part is guided for a horizontal movement between a forming position, wherein the fluid forming tool form part is positioned between the upper and the lower frame plate, and a workpiece removal position, which is horizontally distanced from the forming position. According to this embodiment an fast and efficient removal of the workpiece is made possible by a movement of the tool mold. The forming position may be defined by a position inside the main frame and the workpiece removal position may be defined by a position outside the main frame. The horizontal movement may be perpendicular to the clamping axis.

Still further, it is preferred that the fluid forming tool mold defines a workpiece space such that the workpiece is in direct contact to the upper sealing surface and the lower sealing surface, wherein a pressurized molding fluid is applied via the fluid channel and the pressurized molding fluid is in direct contact to the workpiece when positioned in the workpiece space. According to this embodiment the molding fluid is directly applied to the workpiece, thus allowing high stretch and strain rates of the workpiece and precise molding of fine contours and details at the workpiece. In this case both the upper and the lower sealing surface are preferably directly arranged to be in direct contact with the workpiece.

According to an alternative embodiment hereto, the fluid forming tool mold defines a workpiece space such that the workpiece is in direct contact to one of the upper sealing surface and the lower sealing surface, wherein an elastic molding membrane is disposed between the workpiece and the corresponding other of the lower and upper sealing surfaces, wherein a pressurized molding fluid is applied via said fluid channel and the pressurized molding fluid transfers a molding pressure via said molding membrane to the workpiece such that the pressurized molding fluid is not in direct contact to the workpiece when positioned in the workpiece space. In this embodiment the molding fluid is applied to a molding membrane which acts to transfer the molding pressure onto the workpiece by a direct contact of the molding membrane to the workpiece. By this, a direct contact of the workpiece with the molding fluid is prevented. In this embodiment the molding membrane may form a sealing to the upper tool mold part such that the molding fluid being inserted into a space between the upper tool mold part and the membrane shall not escape to the outside.

It is further preferred that the apparatus comprises a pressure control unit, wherein the pressure control unit is adapted to control the fluid forming pressure to correlate to the fluid closing pressure, and/or to control the fluid forming pressure to be at least 125%, preferably more than 150% of said fluid closing pressure. According to this embodiment the forming pressure is significantly higher than the closing pressure which is, in particular, realized in that the membrane transfers the closing pressure via a larger surface area than the are to which the forming pressure is applied, as described beforehand. It is understood, that the fluid forming pressure may correspond to the pressurized molding fluid source and may have a pressure which is at least 125%, 175%, 200%, or even 250% of the fluid closing pressure which is understood to correspond to the pressurized closure pressing fluid source.

According to a further preferred embodiment, the first closure pressing unit is disposed between the upper frame plate and the upper pressing plate or between the lower frame plate and the lower pressing plate. According to this embodiment, the first closure pressing unit is arranged to compensate for a deformation of the upper frame plate and the upper pressing plate or to compensate for a deformation of the lower frame plate and the lower pressing plate.

According to a further preferred embodiment, the first closure pressing unit is disposed between the upper frame plate and the upper pressing plate and wherein the second closure pressing unit is disposed between the lower frame plate and the lower pressing plate. According to this embodiment, two closure pressing units are provided, wherein the first is arranged to compensate for a deformation of the upper frame plate and the upper pressing plate and the second closure pressing unit is arranged to compensate for a deformation of the lower frame plate and the lower pressing plate.

According to a further preferred embodiment, the first closure pressing unit and the first shifting unit are disposed between the upper frame plate and the upper pressing plate and wherein the second closure pressing unit is disposed between the lower frame plate and the lower pressing plate. According to this embodiment, the first shifting unit is arranged adjacent to the first closure pressing unit and both are positioned between the upper frame plate and the upper pressing plate to compensate for deformations thereof. In this embodiment, two closure pressing units are provided and disposed on both sides of the tool space.

Still further, it is preferred that the first closure pressing unit and the first shifting unit are disposed between the upper frame plate and the upper pressing plate and wherein the second closure pressing unit and the second shifting unit are disposed between the lower frame plate and the lower pressing plate. According to this embodiment, a mirror-symmetrical arrangement of the two closure pressing units and the two shifting units is provided with reference to a horizontal plane being perpendicular to the clamping axis through the tool space.

A further aspect of the invention is a method of fluid forming a metal sheet, comprising the steps:

(a) inserting the metal sheet into an open space between an upper mold part and a lower mold part of a fluid forming tool mold,

(b) fixing and sealing the metal sheet between the upper and the lower mold parts by applying a sealing pressure along a clamping axis,

(c) wherein the sealing pressure is applied by applying a fluid pressure into a fluid cavity delimited by a pressing plate and a membrane, the membrane extending in a direction perpendicular to the clamping axis,

(d) applying a fluid forming pressure via fluid line formed in one of the upper and lower mold parts, and

(e) molding the metal sheet into a mold cavity by the fluid forming pressure, wherein the mold cavity is formed in said other part of said upper and lower mold part.

The method can be further improved in that a shifting step is conducted between step (a) and step (b) , wherein in the shifting step the upper and lower mold parts are shifted in relation to each other to reduce the distance between the upper and lower mold parts by a shifting action, wherein the shifting step is accomplished by
a first relative movement of a recess plate in relation to a protrusion plate in a direction perpendicular to the clamping axis,
the recess plate having a first side and a second side and the protrusion plate having a first side and a second side,
the first relative movement moving the recess plate in relation to the protrusion plate in a position, wherein a recess in the second side of the recess plate is in line with a protrusion of the second side of the protrusion plate with respect to the clamping axis,
a second relative movement of the recess plate in relation to the protrusion plate in a direction along the clamping axis,
the second relative movement moving the recess plate in relation to the protrusion plate in a position, wherein the protrusion is positioned inside the recess.

The method according to the invention allows for an efficient fluid forming process of large sheet metal parts with significant material thickness. It is understood that the method may preferably be accomplished with the fluid forming apparatus as described beforehand. Further, the method may preferably be further improved by incorporating steps corresponding to the features of the preferred embodiments of the apparatus as described beforehand.

### BRIEF DESCRIPTION OF THE DRAWINGS

Preferred embodiments of the invention are described with reference to the appending figures. In the figures:

FIG. 1 is a sectional front view of a first preferred embodiment of the invention;

FIG. 2 is a sectional front view of a second preferred embodiment of the;

FIG. 3a is a sectional front view of a third preferred embodiment of the invention in an open condition;

FIG. 3b is a sectional front view of the embodiment of FIG. 3a in an intermediate position;

FIG. 3c is a sectional front view of the embodiment of FIG. 3a in a closed position;

FIG. 4 is a partial-cut side view of the embodiment of FIG. 1;

FIG. 5 is a top view of a pressure plate having a rectangular membrane; and

FIG. 6 is a sectional side view of a pressure plate having multiple membranes.

### DETAILED DESCRIPTION OF THE EMBODIMENTS

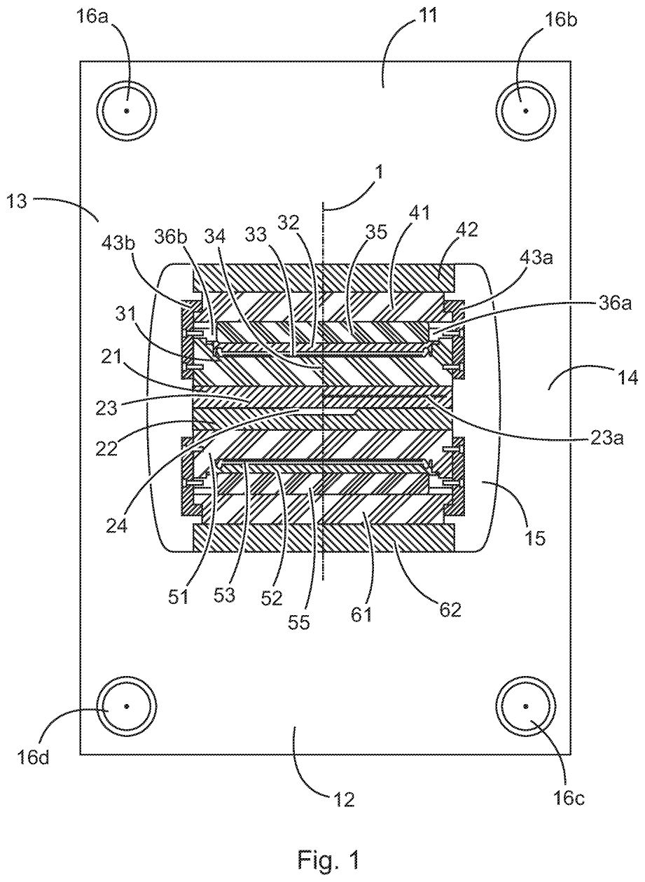

Making reference first to FIG. 1, a frame is shown comprising an upper frame plate 11, a lower frame plate 12, and tensional struts 13, 14. The upper and lower frame plate 11, 12 and the tensional struts 13, 14 circumscribe a tool space 15. The tensional struts 13, 14 are integrally formed as a cutout frame plate. Multiple identical cutout frame plates are arranged side-by-side and parallel to each other to form the frame. The multiple cutout frame plates are mounted to each other and held in a distanced arrangement to each other by bolts with sleeves 16a, 16b, 16c, 16d arranged in the corner sections of the cutout frame plates. The cutout in the frame plates provides the tool space 15.

In the tool space 15, a fluid forming tool mold comprising an upper molding plate 21 and a lower molding plate 22 is positioned. The upper molding plate 21 and the lower molding plate 22 abut each other along a sealing face 23. It is understood that a sheet metal to be formed in a fluid forming process is inserted between the upper and lower fluid forming tool mold plates 21, 22 and thus seals versus the upper and the lower mold plates 21, 22 along said line 23.

In the upper mold plate 21, a pressure channel 23a is present, which serves to direct a pressurized fluid into the middle of the plate and which opens into a cavity 24 provided in the lower mold plate. Thus, a sheet metal placed between the upper and lower mold plates 21, 22 can be deformed into the recess 24 by applying a pressure via the pressure channel 23a.

Above the upper mold plate 21, an upper pressure plate 31 is positioned in abutting contact to the upper mold plate 21. The upper pressure plate 31 sealingly engages a membrane 32 along the circular periphery 32a of the membrane. The membrane is embedded in a cavity having a circular cross section along a clamping axis 1 oriented vertically. The membrane seals a fluid space 33, which is present between the membrane and the upper surface of the upper pressure plate 31. A fluid channel 34 is provided, which opens into said fluid space below the membrane. Via said fluid channel 34, a pressurized fluid can be directed into the fluid space 33 and thus, a pressure exerted onto the membrane.

The membrane 32 is disposed between the fluid space 33 and a stamp plate 35. The stamp plate 35 has a circular cross section with reference to the clamping axis 1 with a diameter corresponding to the diameter of the membrane of being slightly smaller than the membrane. The stamp plate 35 is guided by lateral guiding elements 36a, 36b to allow for a vertical movement along the clamping axis of the stamp plate 35. The stamp plate 35 abuts an upper holding plate 41, which is supported within the upper frame plate 11 via a further distance plate 42. Two lateral clamps 43a, 43b secure the upper pressure plate 31 and the lateral guiding members 36a, 36b to the upper holding plate 41 in such a way as to allow a vertical movement of the upper pressure plate 31 in relation to the upper holding plate 41.

The apparatus shown in FIG. 1 has a mirror-symmetrical arrangement of the components with reference to a horizontal plane coinciding with the sealing plane 23. Thus, a lower pressure plate 51, a fluid space 53, a membrane 52, a lower stamp plate 55, a lower holding plate 61, a lower distance plate 62, lateral guiding elements 56a, 56b, and lateral clamps 63a, 63b are present on the lower part adjacent to the lower mold part in a serial arrangement. By this, a certain amplitude of opening and closing is possible by applying a pressurized fluid into the fluid spaces 33, 53, thus effecting a longitudinal movement of the stamp plates with 35, 55 a downward movement of the lower stamp plate 55 and an upwards movement of the upper stamp plate 35. By this, a closing force can be applied onto the sealing face 23 to seal against a sheet metal inserted along this face. Reducing the pressure will allow opening of the mold to take out a molded part.

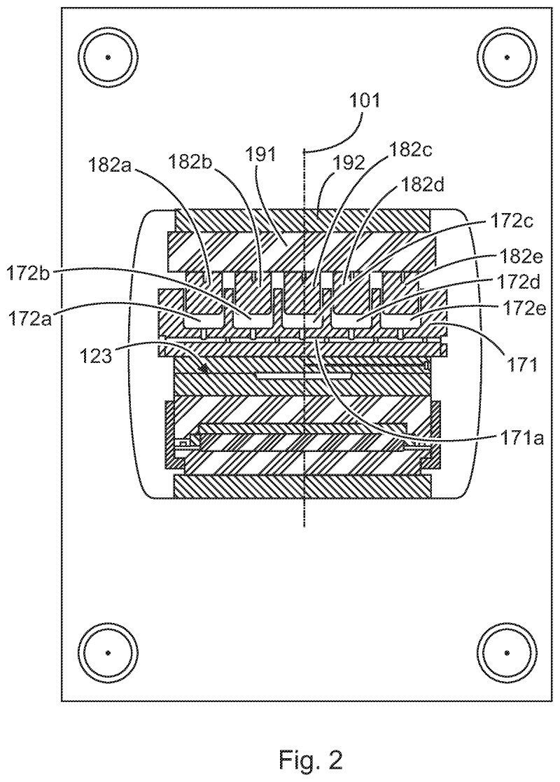

FIG. 2 shows a second embodiment of the invention. The second embodiment is configured identical to the first embodiment in the lower part with reference to a lower mold part 122, a lower pressure plate 151, a fluid space 153, a membrane 152, a stamp plate 155, a holding plate 161, and a distance plate 162.

Further, a similar upper molding part 121 defining a sealing face for inserting a sheet metal between the upper and lower mold parts 121, 122 is configured identical to the first embodiment of FIG. 1.

In contrast to the first embodiment, on the upper side of the fluid forming tool mold 121, 122, a closure pressing unit is positioned, which is composed of a first cylinder block plate 171, wherein a multiple cylindrical recesses 172a, 172b, 172c, 172d, 172e are provided, which are open to the upper face of said cylindrical plate 171. Each of the cylindrical recesses 172a-172e is connected to a fluid channel 171a in the cylinder plate 171. By this a pressure can be exerted into each of the recesses 172a-172e via the fluid channel 171a.

Pistons 182a-182e are positioned in each of the recesses 172a-172e. The pistons 182a-182e are sealingly guided for a vertical movement in the recesses 172a-172e along a clamping axis 101.

The pistons 182a-182e are loosely supported by an upper supporting plate 191. By applying a pressure via the channel 171a, the pistons 182a-182e thus can move vertically inside the recesses 172a-172e to thus allow opening and closing of the fluid forming tool mold and to apply a closing pressure to effect a sealing against a sheet metal inserted along face 123. The upper supporting plate 191 is supported via a distance plate 192 at the upper frame plate.

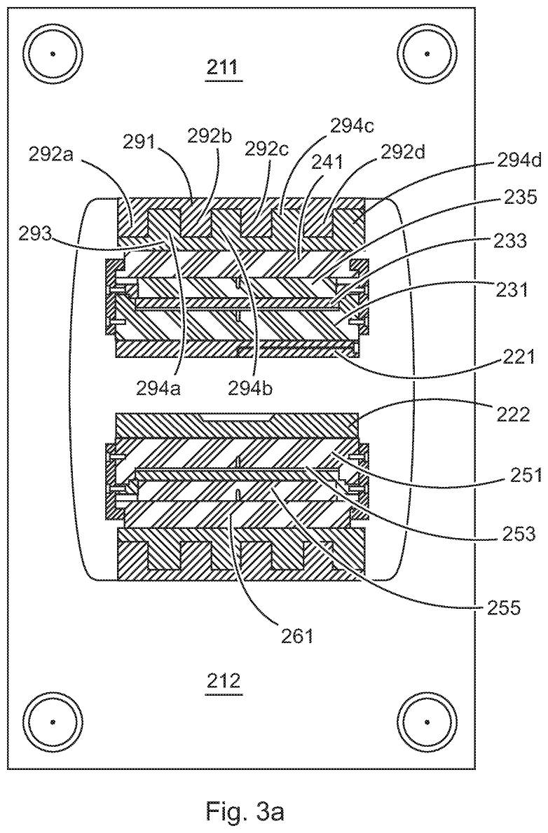

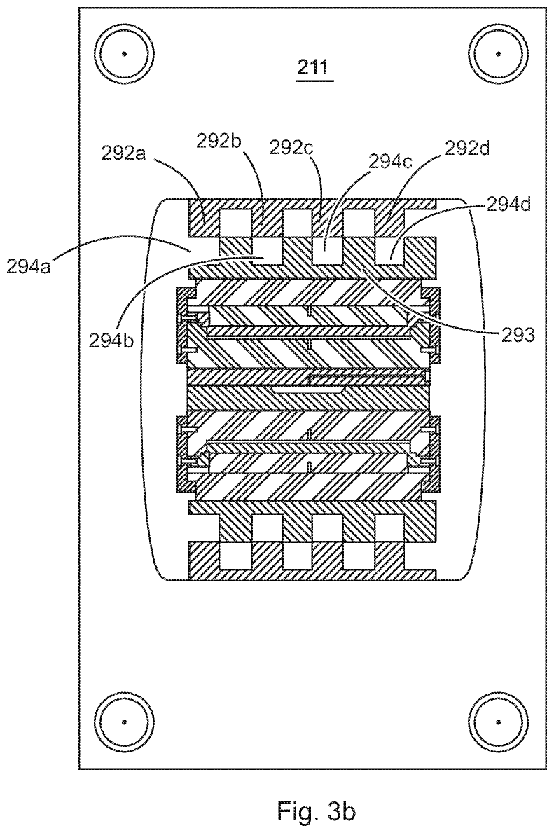

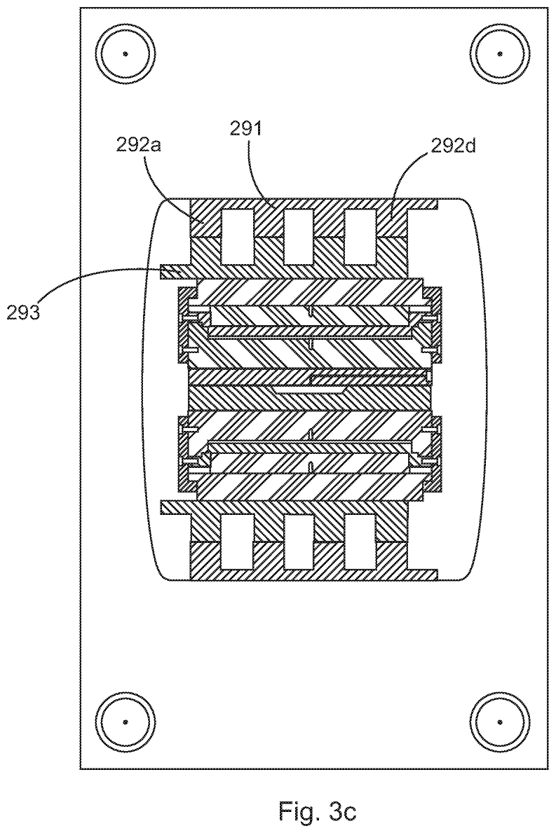

Making reference to FIG. 3a, a third embodiment is shown in an open position. In such open position, a sheet metal can be inserted between the two mold parts 221, 222. The embodiment shown in FIG. 3a is similar with regard to an upper pressure plate 231 and a lower pressure plate 251, an upper fluid space 233 and a lower fluid space 253, an upper membrane 232 and lower membrane 252, an upper stamp plate 235 and a lower stamp plate 255, and an upper holding plate 241 and a lower holding plate 261.

The third embodiment is different from the embodiment shown in FIG. 1 in that a shifting unit is provided between the upper holding plate 241 and the upper frame plate 211 and a further shifting unit is provided between the lower holding plate 261 and the lower frame plate 212.

The upper shifting unit comprises a protrusion plate 291 having a total of four protrusions 292a-292d rising from the upper face of the protrusion plate in a vertical direction. Further, the shifting unit comprises a recess plate 293, comprising a plurality of recesses 294a-294d. The recess plate 293 abuts the upper frame plate 211 and is thus supported for vertical forces thereon.

In FIG. 3a, an open position of the apparatus is shown, wherein the protrusions 292a-292d are fully taken up by the recesses 294a-294d. As can be seen, the protrusion plate 291 is thus fully supported by the recess plate 293 and the height of the protrusion plate and the recess plate is a minimum height in this position.

FIG. 3b shows the embodiment of FIG. 3a in a second position. In this second position, the protrusion plate 291 and the recess plate 293 are displaced in relation to each other in a vertical direction. By this, the protrusions 292a-292d are driven out of the recesses and the fluid forming tool mold is closed by this vertical movement of both the upper mold part and the lower mold part implied by the vertical movement of the protrusion plate 291 of the upper shifting device and the corresponding protrusion plate of the lower shifting device.

FIG. 3c shows a third position, which is a closed and locked position of the apparatus. In this third position, the protrusion plate 291 is moved laterally in relation to the recess plate 293 when compared to FIG. 3b. By this, the protrusions 292a-292d come into abutting contact with the lower side surface of the recess plate sideways from the recesses 294a-294d. By this, a vertical force can be transferred from the protrusion plate to the recess plate and thus a fluid forming process can be conducted in the apparatus. It is understood that for a proper sealing effect, starting from this position, a pressurized fluid can be applied to the fluid space of the pressure closing unit and thus a small shifting induced by this pressurized fluid via the membranes will exert the high closing and sealing force required for the fluid forming process.

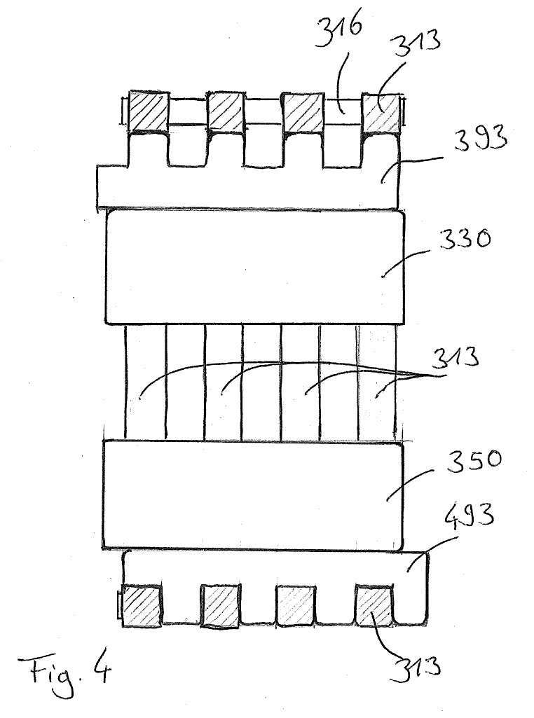

In the lateral view according to FIG. 4 a total of four cutout frame plates 313 can be seen which are held in parallel distanced position by bolts and sleeves 316 in the upper and lower corner sections of the cutout frame plates. The distance between two adjacent cutout frame plates is dimensioned such that protrusions of a recess plate 493 may be inserted between the cutout frame plates in the area of the upper or lower frame plate in a shifted arrangement of the recess plate, as shown for the bottom recess plate 493 in FIG. 4. In an extended position, the protrusions of a recess plate 393 may abut the struts of the cutout frame plates forming the upper or lower frame plate, as shown for the upper recess plate 393 in FIG. 4. By this, an upper molding plate and an upper pressing plate, schematically shown and referenced 330, and a lower molding plate and a lower pressing plate, schematically shown and referenced 350 can be axially driven apart along the longitudinal axis of the fluid forming apparatus.

In FIG. 5 a top view of a pressing plate 431 according to a further preferred embodiment is shown. The pressing plate comprises a membrane 432. As can be seen, the membrane 432 has a rectangular shape and thus, the pressing plate comprises a cavity having a rectangular cross section corresponding to the shape of the membrane. As can be further seen, said rectangular shape and cross section comprise rounded corners to facilitate sealing of the membrane versus said cavity. The pressure plate according to this embodiment may be installed as upper or lower pressing plate.

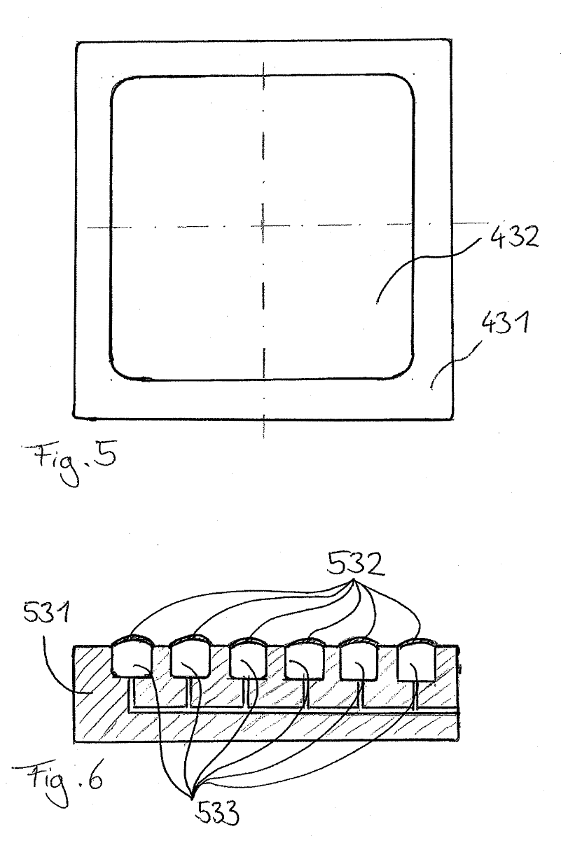

In FIG. 6 a sectional side view of a pressing plate 531 according to a further preferred embodiment is shown. The pressing plate 531 comprises a total of 36 membranes 532. The membranes 532 are arranged in a matrix-like arrangement in rows and line. However, it is understood that the membranes 532 may be arranged in different preferred arrangements like, e.g., an arrangement where the membranes in adjacent rows and line are shifted versus each other. The membranes 532 may have a circular or a rectangular shape or another preferred shape. The pressing plate comprises a plurality of thirty-six cavities 533 having a cross section corresponding to the shape of the membranes 532. The pressure plate according to this embodiment may be installed as upper or lower pressing plate.

1-22. (canceled)

23. A fluid forming apparatus, comprising:
a main frame further comprising at least two tensile frame struts extending along a clamping axis and adapted to carry a tensile force along the clamping axis, wherein the main frame circumscribes an inner frame space which extends along the clamping axis and is delimited by an upper and a lower frame plate at two sides opposed to each other along the clamping axis, and wherein the upper and the lower frame plate are connected with each other by the at least two tensile frame struts;
an upper pressure plate arranged inside the frame space;
a lower pressure plate arranged inside the frame space;
a tool space disposed between the upper and the lower pressure plates, the tool space being adapted to take up a fluid forming tool mold;
a first closure pressing unit arranged inside the frame space in a functional serial arrangement to the upper and lower pressure plates such that by a pressure force exerted by the first closure pressing unit, a pressure closing force along the clamping axis is exerted onto the upper and lower pressure plates;
wherein the upper pressure plate, the lower pressure plate, the tool space and the first closure pressing unit are arranged in a serial arrangement along the clamping axis and the first closure pressing unit comprises a first fluid cavity, the first fluid cavity being delimited by a first flexible membrane and being connected to a pressurized closure pressing fluid source.

24. The fluid forming apparatus according to claim 23, wherein the upper and the lower pressure plates comprise a tool surface area lying in a plane perpendicular to the clamping axis and facing towards the tool space and wherein the first membrane comprises either or both a pressurized membrane face having a size of at least 75% of the tool surface area or a rectangular geometry in a plane perpendicular to the clamping axis.

25. Fluid forming apparatus according to claim 23, wherein the first membrane is composed of a plurality of membranes arranged adjacent to each other and lying in a plane perpendicular to the clamping axis.

26. The fluid forming apparatus according to claim 23, further comprising a first stamp plate, the first stamp plate extending perpendicular to the clamping axis and being displaceable along the clamping axis, wherein the first membrane has a first membrane surface facing towards the fluid cavity and a second membrane surface abutting the first stamp plate.

27. The fluid forming apparatus according to claim 23, further comprising a second closure pressing unit arranged inside the frame space in a functional serial arrangement to the upper and lower pressure plate such that by a pressure force exerted by the second closure pressing unit, a pressure closing force along the clamping axis is exerted onto the upper and lower pressure plates;
wherein the first and the second closure pressing unit, the upper pressure plate, the lower pressure plate, and the tool space are arranged in a serial arrangement along the clamping axis; and
wherein the second closure pressing unit comprises a single or a plurality of second fluid cavities and a corresponding single or a plurality of second flexible membranes, each of the second fluid cavities being delimited by a second flexible membrane and connected to a source of a pressurized fluid.

28. The fluid forming apparatus according to claim 23, further comprising a second closure pressing unit arranged inside the frame space in a functional serial arrangement to the upper and lower pressure plate such that by a pressure force exerted by the second closure pressing unit, a pressure closing force along the clamping axis is exerted onto the upper and lower pressure plates;
wherein the first and the second closure pressing unit, the upper pressure plate, the lower pressure plate, and the tool space are arranged in a serial arrangement along the clamping axis; and
wherein the second closure pressing unit comprises a plurality of second fluid cavities, the second fluid cavities being arranged in an adjacent arrangement in a direction perpendicular to the clamping axis, and wherein a piston is disposed in each of the fluid cavities, the piston sealing the fluid cavity, respectively, and being moveable in a direction along the clamping axis in relation to the fluid cavity.

29. The fluid forming apparatus according to claim 23, further comprising a first shifting unit, the first shifting unit being adapted to be shifted from a shifting minimum height to a shifting maximum height and vice versa, wherein the shifting maximum height minus the shifting minimum height define a shifting amplitude of the first shifting unit;
wherein the first closure pressing unit is adapted to have a closure pressing maximum height defined by a maximum deflection of the first membrane and a closure pressing minimum height defined by the thickness of the membrane, wherein the closure pressing maximum height minus the closure pressing minimum height define a closure pressing amplitude of the first closure pressing unit;
wherein the closure pressing minimum height, the closure pressing maximum height, the shifting minimum height, and the shifting maximum height are oriented in the direction of the clamping axis;
wherein the first shifting unit, the upper pressure plate, the lower pressure plate, the tool space, the first closure pressing unit, and the first shifting unit are arranged in a serial arrangement along the clamping axis; and
wherein the shifting amplitude is at least two times the closure pressing amplitude.

30. The fluid forming apparatus according to claim 23, further comprising a first shifting unit, the first shifting unit comprising a first recess unit having a first side comprising a at least one recess and a first protrusion unit having a first side comprising at least one protrusion, wherein the first side of the first recess unit and the first side of the first protrusion unit face each other;
wherein the first recess unit, the first protrusion unit, the upper pressure plate, the lower pressure plate, the tool space, the first closure pressing unit, and the first shifting unit are arranged in a serial arrangement along the clamping axis; and
wherein the first recess unit and the first protrusion unit extend along a direction perpendicular to the clamping axis and are displaceable in relation to each other in the direction perpendicular to the clamping axis and in a direction along the clamping axis, such that in a first, open position the at least one protrusion of the first protrusion unit is positioned inside the recess to establish a short height of the first shifting unit in a direction of the clamping axis, and in a second, closed position the at least one protrusion of the first protrusion unit is supported on the first side of the first recess unit sideways from the recess to establish a large height of the first shifting unit in the direction along the clamping axis, the large height being larger than the short height.

31. The fluid forming apparatus according to claim 30, further comprising a second shifting unit, the second shifting unit comprising a second recess unit having a first side comprising a at least one recess and a second protrusion unit having a first side comprising at least one protrusion, wherein the first side of the second recess unit and the first side of the second protrusion unit face each other;
wherein the first recess unit, the first protrusion unit, the second recess unit, the second protrusion unit, the upper pressure plate, the lower pressure plate, the tool space and the first closure pressing unit are arranged in a serial arrangement along the clamping axis; and
wherein the second recess unit and the second protrusion unit extend along a direction perpendicular to the clamping axis and are displaceable in relation to each other in the direction perpendicular to the clamping axis and in a direction along the clamping axis, such that in an open position the at least one protrusion of the second protrusion unit is positioned inside the recess to establish a short height of the second shifting unit in a direction of the clamping axis, and in a closed position the at least one protrusion of the second protrusion unit is supported on the first side of the second recess plate sideways from the recess to establish a large height of the second shifting unit in the direction along the clamping axis, the large height being larger than the short height.

32. The fluid forming apparatus according to claim 31, wherein each of the first and the second recess unit comprises at least two recesses and the first and the second protrusion unit comprises at least two protrusions, and wherein each of the protrusions is positioned inside one of the recesses in the open position and each of the protrusions is supported on the first side of the first and second recess unit, respectively, sideways from one of the recesses in the closed position.

33. The fluid forming apparatus according to claim 31, wherein each of the first and the second recess units comprises at least one recess and at least one protrusion and the first and the second protrusion unit comprises at least one protrusion and at least one recess, and wherein each of the protrusions is positioned inside one of the recesses in the open position and each of the protrusions is supported on the first side, respectively, sideways from the at least one recess in the closed position.

34. The fluid forming apparatus according to claim 31, wherein the first recess unit or the first protrusion unit is defined by the upper frame plate or the second recess unit or the second protrusion unit is formed by the lower frame plate, and wherein the upper or lower frame plate comprises a plurality of struts being arranged in a distance to each other such that a space is provided between two adjacent struts, wherein the space forms a recess.

35. The fluid forming apparatus according claim 23, further comprising a fluid forming tool mold, wherein the fluid forming tool mold comprises an upper mold part and a lower mold part, the upper and lower mold part being positioned one on the other in relation to the clamping axis such that an abutting face of the upper mold part faces an abutting face of the lower mold part, the abutting face of the upper mold part establishes an upper sealing surface, and the abutting face of the lower mold part establishes a lower sealing surface;
wherein the sealing surfaces surround a fluid forming cavity provided in an abutting face of one of the upper and lower mold part;
wherein the corresponding other part of the upper and lower mold part comprises a fluid channel connected to a pressurized molding fluid source, the fluid channel having an opening in the abutting face opposed to the fluid forming cavity; and
wherein the upper or lower mold part comprising the fluid forming cavity further comprises a protruding section which protrudes above the sealing surface of the upper or lower mold part comprising the fluid forming cavity in the direction towards the respective other lower or upper mold part.

36. The fluid forming apparatus according to claim 35, further comprising a pressure control unit adapted to control the fluid forming pressure to correlate to the fluid closing pressure or to control the fluid forming pressure to be at least 125%, of the fluid closing pressure;
wherein the pressurized molding fluid source has a pressure higher than the pressurized closure pressing fluid source or the fluid forming tool mold defines a work piece space such that a work piece is in direct contact to the upper sealing surface and the lower sealing surface; and
wherein a pressurized molding fluid is applied via the fluid channel and the pressurized molding fluid is in direct contact to the work piece when positioned in the work piece space.

37. The fluid forming apparatus according to claim 35, further comprising a pressure control unit adapted to control the fluid forming pressure to correlate to the fluid closing pressure or to control the fluid forming pressure to be at least 125%, of the fluid closing pressure;
wherein the pressurized molding fluid source has a pressure higher than the pressurized closure pressing fluid source or the fluid forming tool mold defines a work piece space such that a work piece is in direct contact to the upper sealing surface and the lower sealing surface; and
wherein the sealing surface comprises a first surface section and a second surface section, the first and second surface section being arranged in a distance to each other with respect to a direction along the clamping axis.

38. The fluid forming apparatus according to claim 35, wherein the upper or lower fluid forming tool mold part is guided for a horizontal movement between a forming position, wherein the fluid forming tool form part is positioned between the upper and the lower frame plate, and a work piece removal position, which is horizontally distanced from the forming position.

39. The fluid forming apparatus according to claim 35, wherein the fluid forming tool mold defines a work piece space such that the work piece is in direct contact to one of the upper sealing surface and the lower sealing surface, wherein an elastic molding membrane is disposed between the work piece and the corresponding other of the lower and upper sealing surface, and wherein a pressurized molding fluid is applied via the fluid channel and the pressurized molding fluid transfers a molding pressure via the molding membrane to the work piece such that the pressurized molding fluid is not in direct contact to the work piece when positioned in the work piece space.

40. The fluid forming apparatus according to claim 23, wherein the first closure pressing unit is disposed between the upper frame plate and the upper pressing plate or between the lower frame plate and the lower pressure plate;
wherein the first closure pressing unit is disposed between the upper frame plate and the upper pressing plate and wherein the second closure pressing unit is disposed between the lower frame plate and the lower pressure plate,
the first closure pressing unit and the first shifting unit are disposed between the upper frame plate and the upper pressing plate, wherein the second closure pressing unit is disposed between the lower frame plate and the lower pressure plate, or
the first closure pressing unit and the first shifting unit are disposed between the upper frame plate and the upper pressing plate, wherein the second closure pressing unit and the second shifting unit are disposed between the lower frame plate and the lower pressure plate.

41. The fluid forming apparatus according to claim 23, wherein the tool space is adapted for taking up a sheet material for an external fluid forming process.

42. The fluid forming apparatus according to claim 23, wherein a fluid forming tool is arranged inside the tool space, the fluid forming tool comprising a first section having a molding cavity and a second section having a pressurized fluid line, wherein the first and second section are adapted to sealingly engage a sheet material such that the sheet material is sealingly clamped along a peripheral clamping line between the first and the second section, and wherein the clamping line circumscribes the molding cavity.

43. The fluid forming apparatus according to claim 42, further comprising a pressure control unit adapted to control the pressure of the pressurized closure pressing fluid source applied to the membrane to such a level as to apply a clamping force to the sheet material allowing a small fluid leakage of pressurized forming fluid and a small relative movement of the sheet material through the clamping line.

44. A method of fluid forming a metal sheet, the method comprising the steps of:
inserting the metal sheet into an open space between an upper mold part and a lower mold part of a fluid forming tool mold;
fixing and sealing the metal sheet between the upper and the lower mold part by applying a sealing pressure along a clamping axis;
applying the sealing pressure by applying a fluid pressure into a fluid cavity delimited by a pressure plate and a membrane, the membrane extending in a direction perpendicular to the clamping axis;
applying a fluid forming pressure via fluid line formed in one of the upper and lower mold part; and
molding the metal sheet into a mold cavity by the fluid forming pressure, wherein the mold cavity is formed in the other part of the upper and lower mold part.

45. The method of claim 44, further comprising the step, after the inserting step, of:
shifting the upper and lower mold part in relation to each other to reduce the distance between the upper and lower mold part by a shifting action, wherein the shifting step is accomplished by:
a first relative movement of a recess plate in relation to a protrusion plate in a direction perpendicular to the clamping axis, the recess plate having a first side and a second side and the protrusion plate having a first side and a second side, the first relative movement moving the recess plate in relation to the protrusion plate in a position, wherein a recess in the second side of the recess plate is in line with a protrusion of the second side of the protrusion plate with respect to the clamping axis, and
a second relative movement of the recess plate in relation to the protrusion plate in a direction along the clamping axis, the second relative movement moving the recess plate in relation to the protrusion plate in a position, wherein the protrusion is positioned inside the recess.

46. The method of claim 44, further comprising the step of:
controlling the sealing pressure to be maintained at such a level to allow a movement of the metal sheet through a clamping line established between the metal sheet and the upper mold part or the metal sheet and the lower mold part, wherein the movement is induced by a deformation of the metal sheet caused by the fluid forming pressure.

47. The method of claim 44, wherein the metal sheet conducts a small movement through a clamping line established between the metal sheet and the upper mold part or the metal sheet and the lower mold part.

48. The method of claim 47, further comprising the step of:
controlling the sealing pressure to be maintained at such a level to allow a leakage of fluid under the fluid forming pressure to pass through a clamping line established between the metal sheet and the upper mold part or the metal sheet and the lower mold part.

49. The method of claim 44, wherein the fluid forming pressure fluid passes through a clamping line established between the metal sheet and the upper mold part or the metal sheet and the lower mold part with a small leakage to lubricate the movement of the metal sheet through the clamping line.
